(19) United States
(12) Patent Application Publication
(10) Pub. No.: US 2012/0028015 A1
(43) Pub. Date: Feb. 2, 2012

(54) LAMINATED, TRANSPARENT SET OF PANES, PROCESS FOR PRODUCING AND BENDING SAME, AND USE THEREOF

(76) Inventors: Andreas Langsdorf, Ingelheim (DE); Markus Heiss, Bischofsheim (DE); Doris Moseler, Budenheim (DE); Axel Ohlinger, Wiesbaden (DE); Volker Seibert, Hochheim (DE); Otmar Becker, Langen (DE); Bernd Ruedinger, Woerrstadt (DE); Thilo Zachau, Bensheim (DE)

(21) Appl. No.: 13/186,845

(22) Filed: Jul. 20, 2011

(30) Foreign Application Priority Data
Jul. 23, 2010 (DE) 10 2010 032 092.7

(51) Int. Cl. B32B 7/02; C03B 23/023; B32B 3/00; B32B 17/06; B32B 9/00

(52) U.S. Cl. 428/215; 428/426; 428/688; 428/213; 428/220; 65/106

(57) ABSTRACT

Laminated, transparent set of panes made of brittle materials and interleaved laminated films, wherein the brittle materials are various glasses, special glasses, glass-ceramics, transparent ceramics and crystalline materials, process for producing and bending the set of panes and films, and its use thereof, as a bulletproof, unbreakable and shockproof glazing with a low weight per unit area.

### CROSS-REFERENCE

The invention claimed and described herein below is also described in German Patent Application 10 2010 032 092.7, filed Jul. 23, 2010, which provides the basis for a claim of priority of invention for the invention claimed herein below under 35 U.S.C. 119 (a)-(d).

### BACKGROUND OF THE INVENTION

1. The Field of the Invention

The invention relates to a highly bulletproof, non-planar, in particular two-dimensionally or three-dimensionally bent, transparent glazing with a small overall thickness, in particular for use in protected vehicles. In particular, the invention also relates to a process for producing a non-planar, bulletproof, transparent glazing, in particular for use in vehicles, which has a Stanag 2 bulletproof level and an overall thickness of less than 65 mm, preferably less than 63 mm, and particularly preferably less than 60 mm, in particular a glazing which contains more than one type of brittle material.

2. The Description of the Related Art Bulletproof glazing generally consists of a plurality of panes of glass, special glass, glass-ceramic, transparent ceramic or plastic of special thicknesses, which are laminated onto one another by means of films or synthetic resins. The bullet-proof properties here are essentially determined by the material selection, the strength of the individual materials and the resulting overall thickness. Overall thicknesses of significantly more than 40 mm result in comparatively highly effective bulletproofing, but that is many times greater than the overall pane thicknesses customary in a standard motor vehicle. The thicknesses of the individual panes located in the laminate are also generally much higher than is customary in the case of standard motor vehicle glazing (e.g. in the range of 5-10 mm). In addition, the use of special glasses has proved to be expedient for bulletproof glazing. Use is therefore made of borosilicate glasses, such as BOROFLOAT® 33 and BOROFLOAT® 40, and also glass-ceramics, in order to produce especially bulletproof glazing with a low overall weight per unit area (see also the applicants' application DE 10 2010 013 641.7-45, which has not yet been laid open).

The overall thickness of the composite is important for the use in vehicles, in particular. Specifically, here the visual external appearance of the vehicle should often not be changed at all or at least should be changed as little as possible compared to the unprotected model. The overall thickness of the glazing and the frame structure which supports the composite therefore has to increase into the interior of the vehicle. An excessively high overall thickness therefore leads to a great loss of interior volume and also to a lack of installation space at the corners of the vehicle, which are adjoined by side glazing and front or rear glazing (e.g. A-pillar). For this reason, the desire for the most effective possible bulletproofing is generally limited to military bulletproof classes (e.g. Stanag Level 2 or 3) because of the excessively large thickness of the corresponding glazing. The demand for a small overall thickness of the composite is met by a selected composition of the brittle materials, but also leads to the requirement to use the thinnest possible laminate films, having a thickness of less than 2.54 mm (preferably less than 1.27 mm, particularly preferably less than 0.76 mm, of 0.38 mm or even thinner). In order to make it possible for such thin lamination films to be used, the accuracy of fit of the surfaces of the respective panes which lie one on top of another has to be so good that the lamination film can fill the remaining variation in thickness of the interspace, but without the glass plates making direct contact at any point.

In unprotected motor vehicles, both in automobiles and in commercial vehicles, bent pane geometries have gained acceptance for a relatively long time, e.g. on account of design aspects and the associated, significantly better angle of vision of the driver and improved aerodynamics.

In principle, a bent design is thus also required for bulletproof glazing.

Standard two-pane composite systems can be produced easily: two panes of a small thickness (e.g. 3 mm) are placed one on top of the other in a bending mold, separated by a release agent (e.g. powder or woven mats), and heated to a temperature at which the panes bend onto one another and into the bending mold under their own gravity. The bending temperature here is generally about 625° C. for soda-lime glass, which corresponds to a viscosity of about 10^{10.25} dPas. The time during which the panes are exposed to the bending temperature varies for about a few minutes.

At present, however, there are bent, bulletproof composites only up to specific bulletproof classes (e.g. B6/B7) and with a relatively simple composition (soda-lime glass).

There is extensive prior art for bending motor vehicle glazing, and this is described for example in Moreau, Lochegnies et al., Integration of thermal aspects in the finite element analysis of . . . , Glasverarbeitung [Glass processing] Vol. 2 (1995) pages 53-60; Lochegnies, Marion, Carpentier, Oudin; Finite element contributions to glass manufacturing control and optimisation. Part 1. Creep of flat volumes; Glass Technol. 1996, 37(4), 128-132, or also by way of example in the following patent applications: DE 36 15 225 C2, DE 101 27 090 A1, U.S. Pat. No. 2,827,739.

Bulletproof glazing, in particular glazing which contains different brittle materials, is described for example in the following applications: DE 10 2008 043 718 A1, WO 2009/042877 A2 and DE 42 44 048 C2.

However, the particular production problems are an obstacle to the production of thicker, bent composite systems having a more complex composition.

Although, in principle, the aforementioned production processes are also available for thicker composites with a plurality of panes (as the existence of bent B6 and B7 composites shows) and the corresponding documents also refer in this context to the use of the process for more than two panes, it has been found in practice that here there is increasingly a conflict between the surface quality and contour accuracy. On account of the significantly higher bearing pressure and the significantly slower penetration of heat, the process window for this production process is becoming ever narrower as the number of panes and the laminate thickness increase, and it is becoming more and more difficult to still ensure an acceptable surface quality. Although, in theory, bending can also be carried out without release agents, it has been found in practice that a suitable selection or combination of known or commercially available release agents has an advantageous effect on the surface quality. By way of example, for this purpose it is possible to use the conventional metal or glass fiber non-wovens, pulverulent release agents or release agents suspended in liquids. A further particularly aggravating factor is that the majority of the panes or all of the panes have a thickness of greater than or equal to 5 mm (some even having a thickness of greater than or equal to 8 mm, 10 mm or 15 mm), and can therefore only be bent with particular difficulty.

The consequence of these difficulties is, for example, that there are approaches to bypass them in order to achieve a non-planar outer contour using planar panes of brittle material, as described for example in DE 100 48 566 B4 or DE 195 48 338 C2.

An even more specific problem is represented by bent, bulletproof composites, which consist of more than one type of brittle material. This is the case if both (different) glasses and also glass-ceramics or transparent ceramics or crystals are present in a composite, or if different types of glass which differ considerably from one another in terms of their viscosity curves are present.

The conflict between a high surface quality, on the one hand, and a high accuracy of fit of the panes with respect to one another (in order to allow the use of thin laminate films), on the other hand, results in a very narrow process window, in particular with respect to the bending temperature. An increased temperature leads to an increased amount of surface defects, and a lowered temperature leads to a poorer fit of the panes with respect to one another and therefore to the need to use thicker lamination films than desired, which is undesirable with respect to the resulting weight per unit area and the resulting overall thickness.

If more than one type of glass is to be present in the laminate and the various types of glass differ from one another in terms of their bending process window, a decision has to be made in the standard process as to whether a poorer surface quality or (on account of a poorer accuracy of fit) a thicker lamination film is accepted.

A completely separate problem is represented by bulletproof composites which contain at least one glass-ceramic plate. Glass-ceramics are produced from the melt initially as green glass, which can be converted into a glass-ceramic directly during production or else in a subsequent process. Composites in which some or all of the panes are produced from glass-ceramic prove to be particularly beneficial with respect to the bulletproof properties and are already used as planar laminates.

The aforementioned common bending of glass-ceramic green glass with other glasses does not prove to be beneficial on account of the very greatly differing viscosity curves (ΔT at 10¹² dPas=135 K for the example BOROFLOAT® 33 and glass-ceramic green glass) and the ceramicization process which is then required. The common bending of glasses with an already ceramicized glass-ceramic proves to be even less beneficial, since the viscosities differ even more greatly. The separate bending and ceramicization of the glass-ceramic and subsequent insertion into the bent composite of glass panes is possible. By virtue of the warping, which generally occurs during the ceramicization, it proves to be possible, but complex, to ensure sufficient contour matching between the glass-ceramic and the rest of the composite in a production environment, in order to be able to carry out lamination using the favored thin lamination films.

A similar problem is present if the composite is to contain a brittle material for which no conventional bending process is available at all, for example for transparent ceramics or crystals.

### SUMMARY OF THE INVENTION

It is therefore an object of the invention to laminate plates of differing thickness made of different materials with different viscosities, and to bend said plates such as to achieve both a very good surface quality and a good accuracy of fit with a simple production process.

It is a further object of the invention to provide a bent, transparent set of panes having the smallest possible weight per unit area and a small thickness (less than 65 mm, preferably less than 63 mm, particularly preferably less than 60 mm).

According to the present invention, the following surprising correlation has been identified:

Although, according to accepted experiences, the large thickness of the glass plates present actually requires a relatively small bending viscosity, in order to obtain the bending radii required, the reverse route has been taken according to the invention.

An even higher lowest bending viscosity of greater than 10¹² dPas, preferably even greater than 10^{12.5} dPas or greater than 10¹³ dPas compared to the conventional bending viscosities was selected for the relatively higher-viscosity glass. In order to achieve any kind of bending effect, the viscosity of the relatively higher-viscosity glass should be below 10^{14.5} dPas for the bending.

The viscosity in that range is determined here via a VFT approximation according to DIN ISO 7884-1 from viscosity data measured according to DIN ISO 7884-4.

For typical glasses, the following table indicates the temperatures at which the materials have a viscosity of about 10¹² dPas or about 10¹³ dPas.

| | Soda- | BORO- | BORO- | Glass-ceramic |
|---|---|---|---|---|
| | lime | FLOAT ® | FLOAT ® | green glass |
| | glass | 33 | 40 | example |
| T (\acute{η} = | 565° C. | 595° C. | 625° C. | 730° C. |
| 10¹² dPas) | | | | |
| T (\acute{η} = | 545° C. | 565° C. | 600° C. | 695° C. |
| 10¹³ dPas) | | | | |

it is advantageous to set a long holding period at this temperature of greater than 2 h, preferably greater than 5 h, particularly preferably greater than 10 h, for which the relatively higher-viscosity glass to be bent has to be in these viscosity ranges in total. Such extremely long times are practically no longer presentable in conventional continuous bending furnaces. As a result of this unusual procedure, even stacks of panes having an overall thickness of more than 50 mm, even more than 80 mm, have been bent with a good surface quality.

In order to assess the optical quality or the transparency quality of a bent and laminated stack of panes or composite, the method described below is used. This method is called the Fourier method.

Digital images of a defined circular structure are taken using a suitable microscopy set up, which has a sufficient working distance. The circular structure consists of five black rings on a white background, where the thickness of the black rings corresponds to the distance between them and is 0.5 mm. The diameter of the entire circular structure is 10 mm.

In order to determine the optical quality, firstly the bent and laminated stack of panes and secondly a reference are moved into the beam path between the microscopy set up and the circular structure, and a respective image of this structure is taken. The reference here is a laminated stack of panes which consists of the same composition as the stack to be assessed, which was laminated untreated in the same thickness sequence. The Fourier transforms of the two images thereby taken are then determined.

Since the amplitude values of high frequencies are stronger in the Fourier-transformed image of a sharp-edged structure than in the Fourier-transformed image of a less sharp structure, the total sum of the amplitude values (the histogram sum) over the entire Fourier-transformed image is greater in a sharp original image than in a blurred original image. A quantitative assessment of the optical quality of the bent stack can then be established by relating the amplitude sum thereby determined to the corresponding amplitude sum of the reference stack.

With the high surface qualities, which can be achieved by the bending process described, the optical quality value thereby determined is above 90%, above 95%, preferably above 97.5%, particularly preferably above 99% over the entire area, but at least in all points at a distance of more than 10 cm from the pane edge.

In particular, it has also thereby been possible to bend stacks of panes containing glass panes of greatly differing thickness.

This process has also made it possible for the first time to produce a bent composite with a good surface quality for lamination with films having a thickness of less than 2.57/1.27/0.38 mm between the brittle materials, which composite contains two different brittle materials, the temperatures of which, corresponding to the viscosity of 10¹² dPas, lie more than 10 K to 50 K apart (for BOROFLOAT® 33 and BOROFLOAT® 40, this difference is about 30 K, for example).

Here, it is preferable that at least half of the laminated films inserted between the brittle materials do not exceed the thickness of 0.38 mm.

A supportive approach to the solution is to deliberately apply temperature gradients over the thickness of the stack of panes during bending, such that the type of glass with the relatively higher viscosity is at higher temperatures. This can easily be achieved, for example, if the higher-viscosity type of glass is at the top during bending, as a result of a short, intense top heat, which occurs only to a much weakened extent in the interior of the stack as a result of the thermal inertia. This can be reinforced in that e.g. a release agent (e.g. a woven fleece) reduces the transfer of heat between the higher-viscosity materials and the lower-viscosity materials.

If the viscosity curves of the two or more brittle materials to be bent are so far apart over the temperature that there is no expedient temperature range for common bending, another procedure is more advantageous. This is generally the case when there is no temperature at which the materials to be bent simultaneously have a viscosity in the range of 10¹¹ dPas to 10¹⁴ dPas. This also applies to materials for which conventional bending cannot be carried out (e.g. transparent ceramics and crystals) and which have to be produced or supplied with a bent geometry in another way.

For this purpose, the material with the relatively highest viscosity is firstly bent into shape (in the case of glass-ceramic also ceramicized) or provided with a bent geometry. If the material with the relatively highest viscosity involves more than one pane, these are bent together, in the case of glass-ceramic also ceramicized together. The bent pane which is obtained or is present then serves as a convex and/or concave bending mold for a next bending step with the material which has the next lower viscosity. Here, the pane serving as the bending mold can for its part be mounted in a mold. This is advantageous particularly when said pane still has residual deformability at the bending temperature of the panes to be bent next. This process should be carried out until all brittle materials are bent. The brittle panes used as bending molds remain in the final composite, and the bending mold in each case becomes a constituent part of the transparent composite to some extent.

If the sequence of the brittle materials in the composite is selected such that only a single viscosity maximum, and otherwise only monotonous viscosity sequences, occurs at a pane position when the viscosity pertinent to a bending temperature is applied over the position on the surface normal (inside=>outside with respect to the composite), this process can be followed.

If a plurality of viscosity maxima occur, either one of the two panes with maximum viscosity can be inserted using an individual bending process, if appropriate with the need for a more complicated bending process for achieving the contours or the use of greater film thicknesses for compensating for corresponding deviations.

Depending on the bending contour and the required thickness of the film, the panes can be matched better, in this case for the common bending, by resorting the brittle materials as compared with the ultimately desired sequence, such that in turn only a single viscosity maximum is present, and so the aforementioned process is likewise applicable, and by then bringing the brittle materials back into the desired sequence before the lamination. The gap thickness deviations thereby induced can be determined by geometrical deliberations and often lie only in a tolerable order of magnitude.

By virtue of the process approaches explained above, it has been possible for the first time to also provide bulletproof pane systems which are highly bulletproof as a result of suitable material and thickness combinations, despite a small weight per unit area, as are also described for example in the applicant's application DE 10 2010 013 641.7-45, which has not yet been laid open, with a non-planar or bent geometry.

The aforementioned process approaches can be used for the widest variety of required product geometries. This may involve single-axis bendings (2D), which are of interest for example for side panes of automobiles, or else 3D bendings with a plurality of radii, also in various spatial directions.

It goes without saying that the selection of the bending duration also depends on the desired bending radii. The times indicated are typical for bending radii in the order of magnitude of 800 mm or greater. For smaller desired bending radii, the bending duration generally has to be selected to be longer again. Radii of 200 mm could also be provided however using the process approaches explained above.

It goes without saying that the two approaches described and claimed herein below (common bending and successive bending) can be combined, for example, in such a way that plates having differences in viscosity which permit common bending can be bent together and only those plates whose viscosity differs to a greater extent are integrated using the successive bending approach.

It also proves to be expedient to use at least one so-called sacrificial plate, which, during the bending, is positioned underneath the lowermost plate, which is intended to also become a constituent part of the composite.

The sacrificial plate can have a number of advantageous effects, such as
a damaged glass surface in particularly critical contact with the mold surface will not become a constituent part of the product composite;
the lowermost pane generally does not rest on the mold over the entire surface area during bending processes, which leads to increased bearing pressures in the region of the bearing surfaces and thus to increased surface defect formation. These surface defects do not become part of the product because of the use of a sacrificial plate;
particularly if the lowermost or the lower product pane(s) is/are dimensioned to be greater during bending than the panes lying above, it may be the case that the lowermost product pane or panes is (are) unable to bear the overall weight of the stack of panes (risk of fracture) over the bearing points on the mold. Here, the at least one sufficiently thick sacrificial pane can absorb the load;
a favorable variant of the bending process is one in which all the panes are lowered as uniformly as possible into the bending mold. If the lowermost plate, on account of the viscosity curve, temperature distribution and plate thickness, is not the slowest bending plate in the stack, this uniform bending of all the panes can be ensured via the braking action of a suitably selected sacrificial pane. For this reason, the type of glass (viscosity curve) and material thickness of the sacrificial plate are selected appropriately;
if the bending mold (such as e.g. in the case of the composite containing glass-ceramic) becomes a constituent part of the composite, it may be expedient to also protect the mold itself with a—then bent—sacrificial plate. In this case, it may therefore be advantageous to combine a bent sacrificial plate on the mold with a planar sacrificial plate underneath the stack of panes to be bent;
if incompletely closed molds are used, such as e.g. molds which define the bending contour only by non-all-over bearing, the sacrificial plate prevents or reduces the depiction of the bearing structure of the mold on the composite;
in cases where the composite does not exactly achieve the mold contour or no complete mold contour is predefined at all (e.g. in the case of so-called frame molding), a sacrificial plate ensures that at least the fit of the panes with respect to one another is always sufficiently good for lamination with a thin film.

According to the invention, these advantages are therefore realized
in that the lowermost layer used for the common bending is at least one sacrificial plate, which will not become a constituent part of the composite to be produced,
in that the at least one sacrificial plate has a thickness which is greater than or equal to the thickest thickness of brittle material present in the composite to be produced,
in that the at least one sacrificial plate consists of the brittle material to be bent which has the relatively highest viscosity, or a material which relatively has an even higher viscosity.

Depending on the bending radius, the overall thickness and permissible surface defects and permissible contour tolerances, it is even possible to simultaneously bend a plurality of stacks of panes which are to be bent and lead to a window one above another in a bending mold. The absolute contour deviation which occurs ensues from geometrical deliberations.

In order to shorten the long bending times which result from the high viscosity during the bending, it is also possible to additionally utilize any of the known processes for applying an additional force component in the desired bending direction, such as the use of a plunger from above or the suitable application of excess pressure from above or negative pressure below and, if appropriate, between the panes.

If chemically tempered panes are provided in the composite, these can generally be tempered after the bending, without damaging impairment of the contours.

Since small thicknesses and a low weight per unit area can be achieved only via complex structures in combination with various brittle materials (see e.g. DE 10 2008 043 718 A1, WO 2009/042877 A2, DE 42 44 048 C2, which were only available in planar form), the process mentioned above has made it possible for the first time to also provide high bulletproof classes with small thicknesses and low weights per unit area with a non-planar form.

In particular, it has been possible for the first time to produce a non-planar vehicle glazing, which has a Stanag 2 protection level and an overall thickness of less than 60 mm and laminate film thicknesses, which were laminated at least one position between two brittle materials, of less than 1.27 mm, preferably 0.76 mm, particularly preferably 0.38 mm or less. With respect to the Stanag protection level, reference is made to AEP-55, Volume 1, Edition 1 (NATO) dated February 2005.

In all of the aforementioned cases, it can be expedient and necessary that parts of the surface area at the edge are not formed in the complete composite thickness, but rather projections e.g. of the outermost pane of brittle material are provided (as is provided e.g. in DE 10 048 566 B4 from polycarbonate). This can either be done after the bending by appropriate edge processing of the panes, or else appropriately dimensioned panes are already bent in the bending process. All statements relating to the thickness and the like in this case analogously relate to the main part of the laminate, which has the greatest thickness and therefore the correspondingly established bullet-proof standards.

Furthermore, the invention relates in particular to such non-planar, bulletproof glazing in which the surface normals of the individual brittle panes forming the composite are substantially parallel to one another and to the inner and outer composite surface at substantially every point of the bulletproof glazing.

The glazing can also be provided, e.g. on the inner surface, with a transparent polymer layer typically having a thickness of 2-15 mm. This can either be bent into the corresponding pane of brittle material analogously to the successive bending procedure at a conventional bending temperature specific to the material or can be applied with initially elastic bending without the influence of temperature before the lamination process, laminated on via the lamination process and possibly relaxed.

### BRIEF DESCRIPTION OF THE DRAWING

The objects, features and advantages of the invention will now be illustrated in more detail with the aid of the following description of the preferred embodiments, with reference to the accompanying figures in which:

FIGS. 1a to 1c are cross-sectional action views showing steps of one embodiment of a process for making a laminated, transparent set of panes and transparent interleaved layers according to the invention; and

FIGS. 2a to 2g are cross-sectional action views showing steps of another embodiment of a process for making a laminated, transparent set of panes and transparent interleaved layers according to the invention.

### DESCRIPTION OF THE ILLUSTRATED EMBODIMENTS

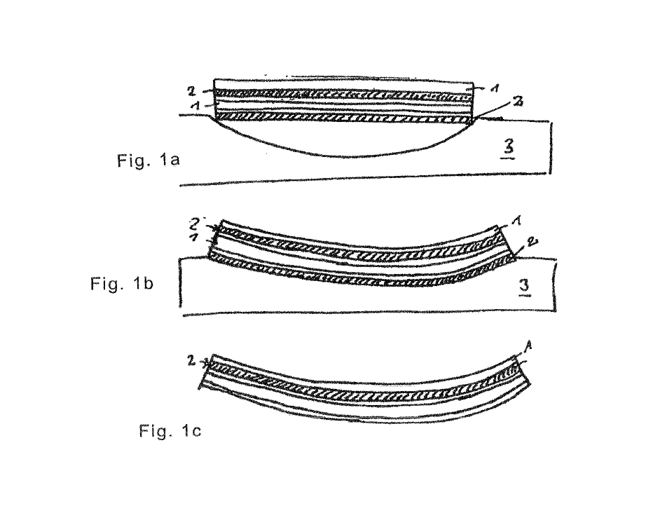

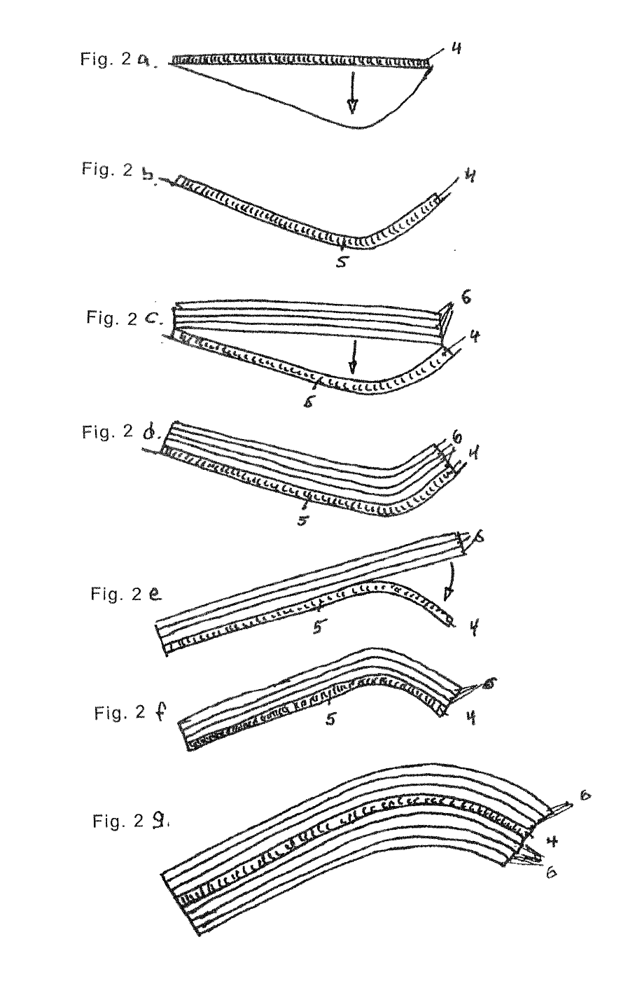

The process according to the invention will be explained in more detail with reference to the exemplary embodiments shown in FIG. 1 and FIG. 2.

FIGS. 1a to 1c illustrate successive bending steps of a process for making a laminated, transparent set of panes and transparent interleaved layers according to the invention. FIGS. 1a and 1b show the common bending of panes 1 of BOROFLOAT® 33 and panes 2 (shown hatched) of BOROFLOAT® 40 with a sacrificial plate 3 of BOROFLOAT® 40 at a temperature of 580° C. The bending radius is 2300 mm and the panes have a dimension of about 600 mm×600 mm. The respective temperatures at which BOROFLOAT® 33 and BOROFLOAT® 40 both have a viscosity of 10¹² dPas are 595° C. and 625° C. At the selected temperature of 580° C., BOROFLOAT® 33 has a viscosity of about 10^{12.4} dPas and BOROFLOAT® 40 has a viscosity of about 10^{13.7} dPas. The bending duration is 12 h. The finished product of the bending is illustrated in FIG. 1C.

FIGS. 2a to 2g illustrate successive bending steps of a process for making a BOROFLOAT® composite according to the invention. FIGS. 2a to 2g shows the bending of the BOROFLOAT® composite containing a pane 4 of glass-ceramic (shown hatched in the figures) in a plurality of steps.

The initial steps of the process illustrated in FIGS. 2a and 2b are the bending and ceramicizing of the pane 4 of glass-ceramic material.

In the following steps of the process illustrated in FIGS. 2c and 2d the pane 4 of glass-ceramic material is used as a concave bending mold 5 for bending panes 6 of BOROFLOAT® on the inside of the composite.

In the subsequent steps following those illustrated in FIGS. 2c and 2d, which are illustrated in FIGS. 2e and 2f, the pane 4 of glass-ceramic material is used as a convex bending mold 5 for bending the panes 6 of BOROFLOAT® that are located on the outside of the composite.

The complete resulting composite with the glass-ceramic 4 in between panes 6 of BOROFLOAT® is illustrated in FIG. 2g.

While the invention has been illustrated and described as embodied in a laminated, transparent set of panes, process for producing and bending same, and uses thereof, it is not intended to be limited to the details shown, since various modifications and changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed is new and is set forth in the following appended claims.

We claim:

1. A laminated, transparent set of panes made of brittle materials and transparent interleaved layers made of casting resins or polymer films, wherein the brittle materials are selected from, the group consisting of glasses, special glasses, glass-ceramics, transparent ceramics and crystals.

2. The laminated, transparent set of panes and transparent interleaved layers according to claim 1, containing at least two different ones of said brittle materials, and wherein temperatures of said at least two different ones of said brittle materials, which correspond to brittle material viscosities of 10¹² dPas, are separated from each other by at least 10 K.

3. The laminated, transparent set of panes and transparent interleaved layers according to claim 1, wherein said interleaved layers between the panes of the brittle materials have respective thicknesses that do not exceed 1.27 mm at least one location.

4. The laminated, transparent set of panes and transparent interleaved layers according to claim 3, wherein said respective thicknesses do not exceed 0.76 mm at said at least one location.

5. The laminated, transparent set of panes and transparent interleaved layers according to claim 3, wherein said respective thicknesses do not exceed 0.38 mm at said at least one location.

6. The laminated, transparent set of panes and transparent interleaved layers according to claim 3, wherein at least two of said respective thicknesses differ by a factor of 1.3 to 2.

7. The laminated, transparent set of panes and transparent interleaved layers according to claim 1, which are bent.

8. The laminated, transparent set of panes and transparent interleaved layers according to claim 1, which has a transparency measured by a Fourier method with a value of greater than 90% at least at all points at a distance of more than 10 cm from an edge of one of said panes.

9. The laminated, transparent set of panes and transparent interleaved layers according to claim 1, wherein said value of said transparency is greater than 97.5% at least at all of said points.

10. The laminated, transparent set of panes and transparent interleaved layers according to claim 1, wherein said value of said transparency is greater than 99% at least at all of said points.

11. The laminated, transparent set of panes and transparent interleaved layers according to claim 1, which has an anti-shatter layer and a Stanag 2 protective level.

12. The laminated, transparent set of panes and transparent interleaved layers according to claim 11, having an overall thickness of less than 65 mm.

13. The laminated, transparent set of panes and transparent interleaved layers according to claim 12, wherein said overall thickness is less than 63 mm.

14. The laminated, transparent set of panes and transparent interleaved layers according to claim 12, wherein said overall thickness is less than 60 mm.

15. A process of producing a laminated, transparent set of panes and transparent interleaved layers according to claim 1, said process including the step of bending together at least two of said panes formed from the brittle material.

16. The process according to claim 15, wherein all of said panes formed from the brittle material are bent together.

17. The process according to claim 15, wherein the overall duration of the bending is more than 2 h.

18. The process according to claim 17, wherein the overall duration is more than 5 h.

19. The process according to claim 17, wherein the overall duration is more than 20 h.

20. The process according to claim 15, wherein the brittle materials comprise a glass with a highest viscosity in comparison to others of the brittle materials and wherein during the bending the viscosity of the glass is greater than 10¹² dPas.

21. The process according to claim 20, wherein said viscosity of said glass is greater than 10^{12.5} dPas.

22. The process according to claim 20, wherein said viscosity of said glass is greater than 10¹³ dPas.

23. The process according to claim 15, which comprises a plurality of bending steps, in which the panes of respective ones of said brittle materials which have a higher viscosity than that of a second or further one of the brittle materials at a bending temperature of said second or further one of the brittle materials have an already bent contour and act as a negative or positive or convex or concave bending mold for the panes of the second or further brittle material.

24. The process according to claim 23, wherein the panes of the brittle materials acting as the bending mold become a part of the laminated, transparent set of panes and transparent interleaved layers.

25. The process according to claim 15, wherein a sequence of the panes is changed for the bending steps compared to the laminated, transparent set of panes to be produced.

26. The process according to claim 15, wherein a lowermost layer used for common bending is at least one sacrificial plate, which does not become part of the laminated, transparent set of panes and transparent interleaved layers that is produced.

27. The process according to claim 26, wherein said at least one sacrificial plate has a thickness which is greater than or equal to a thickest of the panes of the brittle material present in the laminated, transparent set of panes and transparent interleaved layers that is produced.

28. The process according to claim 26, wherein said at least one sacrificial plate is made of the one of the brittle materials to be bent having a highest viscosity of all the brittle materials to be bent.

29. The process according to claim 15, further comprising generating a temperature gradient at least temporarily during the bending, such that viscosity-curve-related differences in viscosities of the brittle materials are at least partially compensated for by the temperature gradient.

30. A bulletproof, unbreakable and shockproof glazing for vehicles, which has a Stanag 2 protective level, said glazing comprising a laminated, transparent set of panes and transparent interleaved layers according to claim 1.

31. The glazing according to claim 30, wherein said set of panes is bent according to a process including the step of bending together at least two of said panes formed from the brittle material.

32. The glazing according to claim 30, wherein said vehicles are aircraft or ships.
